(19) United States
(12) Patent Application Publication
(10) Pub. No.: US 2025/0074520 A1
(43) Pub. Date: Mar. 6, 2025

(54) TRAVEL DRIVING APPARATUS

(71) Applicant: KOMATSU LTD., Tokyo (JP)

(72) Inventors: Yugo NOGI, Tokyo (JP); Kazuyuki SAKAI, Tokyo (JP); Yoshihiro SAKAI, Tokyo (JP)

(21) Appl. No.: 18/726,631

(22) PCT Filed: Jan. 26, 2023
(86) PCT No.: PCT/JP2023/002343

§ 371 Date: Jul. 3, 2024

(30) Foreign Application Priority Data
Mar. 29, 2022 (JP) 2022-053617

(51) Int. Cl. B62D 55/12; B62D 55/15

(52) U.S. Cl. CPC B62D 55/12; B62D 55/15

(57) ABSTRACT

A travel driving apparatus in a work machine includes an output shaft to which driving force is output from a reducer of the work machine, a sprocket hub, a housing, and a floating seal. The sprocket hub includes an inner face portion disposed on a side of the reducer. The sprocket hub is connected to the output shaft. The housing includes an outer face portion that faces the inner face portion. The housing covers the reducer from a side of the sprocket hub. The floating seal is disposed at an end portion of a space formed between the inner face portion and the outer face portion. The space us filled with lubricating oil.

### CROSS-REFERENCE TO RELATED APPLICATIONS

This application is a U.S. National stage application of International Application No. PCT/JP2023/002343, filed on Jan. 26, 2023. This U.S. National stage application claims priority under 35 U.S.C. § 119 (a) to Japanese Patent Application No. 2022-053617, filed in Japan on Mar. 29, 2022, the entire contents of which are hereby incorporated herein by reference.

### BACKGROUND

### Technical Field

The claimed invention relates to a travel driving apparatus.

### Background Information

In working machines such as bulldozers, a crawler-type travel driving apparatus is used. The crawler-type travel driving apparatus rotates and drives its crawler by rotating a sprocket (see, for example, Japanese Patent Application Publication No. 2002-178963).

In the travel driving apparatus disclosed in Japanese Patent Application Publication No. 2002-178963, a support shaft is rotated by a travel motor, and a sprocket fixed to the support shaft is rotated. The support shaft is rotatably supported by an output-side housing via a bearing. A floating seal is provided between the output-side housing and the sprocket for sealing lubricating oil that lubricates the bearing and the like and for preventing earth, sand, and the like from entering from the outside.

### SUMMARY

The floating seal described above requires regular servicing including inspection, maintenance, and replacement. The structure of the floating seal shown in Japanese Patent Application Publication No. 2002-178963, however, does not have satisfactory serviceability.

An object of the present disclosure is to provide a travel driving apparatus in which the serviceability can be improved.

A travel driving apparatus according to a first aspect of the present disclosure is a travel driving apparatus in a work machine having a reducer, and includes an output shaft, a sprocket hub, a housing, and a floating seal. The driving force is output from the reducer to the output shaft. The sprocket hub has an inner face portion disposed on a side of the reducer and is configured to be connected to an output shaft of the reducer. The housing has an outer face portion that faces the inner face portion, and covers the reducer from a side of the sprocket hub. The floating seal is disposed at an end portion of a space that is formed between the inner face portion and the outer face portion and the space is filled with lubricating oil.

According to the present disclosure, it is possible to provide a travel driving apparatus in which the serviceability is improved.

### BRIEF DESCRIPTION OF THE DRAWINGS

FIG. 1 is a perspective view showing a bulldozer according to an embodiment of the present disclosure.

FIG. 2 is a cross-sectional view showing the travel driving apparatus according to the embodiment of the present disclosure.

FIG. 3 is an enlarged cross-sectional view of an inner peripheral portion of the travel driving apparatus and the vicinity thereof according to the embodiment of the present disclosure.

FIG. 4 is an enlarged cross-sectional view of a floating seal of the travel driving apparatus and the vicinity thereof according to the embodiment of the present disclosure.

### DETAILED DESCRIPTION OF EMBODIMENT(S)

A travel driving apparatus of an embodiment according to the present disclosure will be described with reference to the drawings.

### (Structure)

### (Outline of Bulldozer 1)

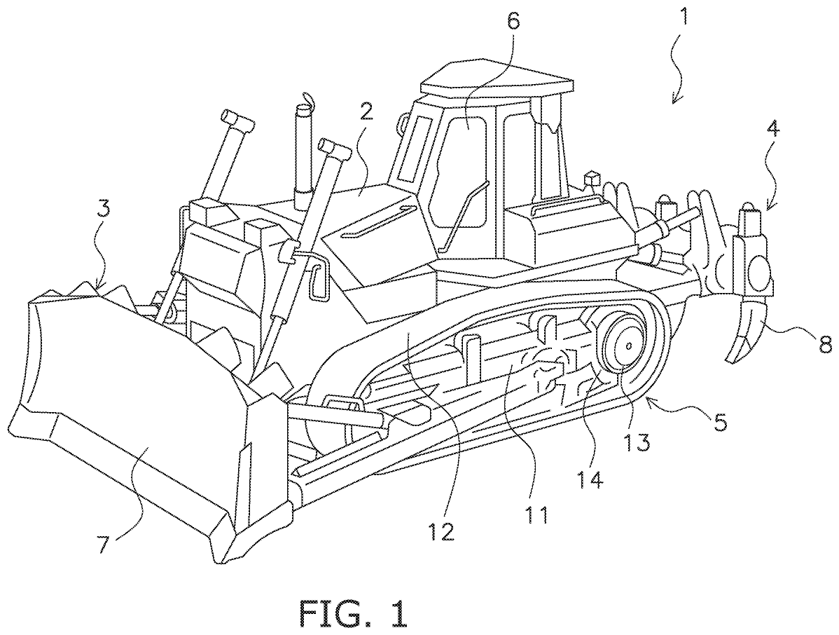

FIG. 1 is a perspective view showing a bulldozer 1 (an example of a work machine) that uses a travel driving apparatus of the present embodiment. The bulldozer 1 includes a vehicle body 2, a work device 3, a ripper device 4, and a traveling device 5. A driver's cab 6 is disposed in the vehicle body 2. The work device 3 is arranged in front of the vehicle body 2. The work device 3 has a blade 7 for works such as soil excavation. The ripper device 4 is arranged behind the vehicle body 2. The ripper device 4 has a claw section 8 for crushing earth, sand and the like.

The traveling device 5 is arranged on the vehicle body 2. The traveling device 5 includes a pair of left and right truck frames 11, a crawler belt 12 disposed around each of the truck frames 11, and a travel driving apparatus 13 disposed on each of the truck frames 11. In FIG. 1, only the truck frame 11, the crawler belt 12, and the travel driving apparatus 13, which are located on the left side, are shown.

The pair of truck frames 11 are each arranged on the outside of the vehicle body 2 in the left-right direction. The crawler belt 12 is arranged around each of the truck frames 11. The travel driving apparatus 13 is arranged in each of the truck frames 11. Each travel driving apparatus 13 is supported by a support section 14 at the rear of each truck frame 11. Each crawler belt 12 is rotated by the travel driving apparatus 13, so that the bulldozer 1 travels.

Note that, in the present embodiment, the front, rear, left, and right directions are described using the driver's seat in the driver's cab 6 as a reference. The direction in which the driver's seat of the driver's cab 6 faces the front is defined as the front direction, and the direction opposite the front direction is defined as the rear direction. The right side and the left side in the lateral direction when the driver's seat faces the front are defined as the right direction and the left direction, respectively. The left-right direction is also referred to as the vehicle-width direction.

### (Travel Driving Apparatus 13)

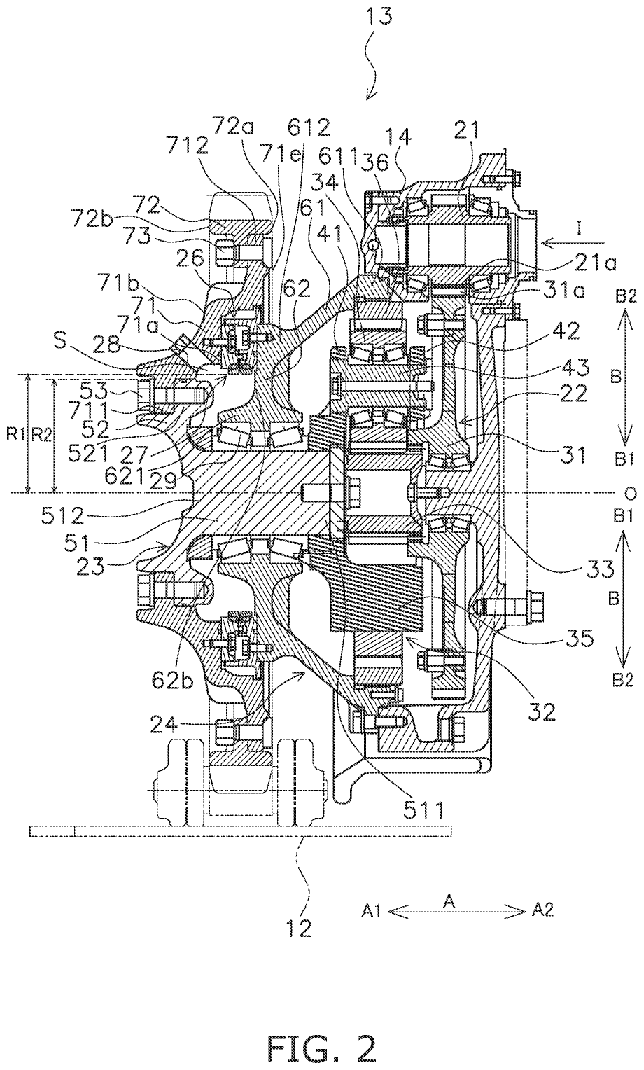

FIG. 2 is a cross-sectional view showing the travel driving apparatus 13. FIG. 2 shows the travel driving apparatus 13 located on the left side of the bulldozer 1. The travel driving apparatus 13 includes an input shaft 21, a reducer 22, an output shaft 23, a housing 24, a sprocket hub 71, a sprocket tooth 72, a labyrinth section 26, a floating seal 27, and a maintenance hole 28.

### (Input Shaft 21)

Driving force is input to the input shaft 21 from a travel motor (not shown) (see arrow 1). The input shaft 21 is arranged along the left-right direction. The input shaft 21 is rotatably supported by the support section 14 of the truck frame 11. The input shaft 21 has a tooth surface 21a around its periphery. The tooth surface 21a is in mesh with the input gear 31 of the reducer 22. Note that, the travel motor used as a power source is a hydraulic motor, but an electric motor may also be used instead. Further, any additional structure may be mounted to rotate the input shaft 21, in which power is directly transmitted from an output shaft of an engine. The input shaft 21 may be rotated by the power from a power source via a transmission.

### (Reducer 22)

The reducer 22 includes an input gear 31 and a planetary gear mechanism 32. The input gear 31 rotates around a central axis O along a vehicle-width direction A. In the vehicle-width direction A, the direction toward the outside with respect to the center of the vehicle width is shown as an outward direction A1, and the direction toward the center is shown as an inward direction A2. In the radial direction B perpendicular to the central axis O, the direction approaching the central axis O is shown as an inward direction B1, and the direction away from the central axis O is shown as an outward direction B2.

The input gear 31 is arranged to the inward-direction A2 side of the planetary gear mechanism 32 in the vehicle-width direction A. The input gear 31 is arranged under the input shaft 21. A tooth surface 31a of the input gear 31 is in mesh with the tooth surface 21a of the input shaft 21.

The planetary gear mechanism 32 includes a sun gear 33, a plurality of planetary gears 34, a planetary carrier 35, and a ring gear 36.

The sun gear 33 is arranged coaxially with the central axis O. The sun gear 33 rotates around the central axis O. The sun gear 33 is in mesh with the input gear 31.

The plurality of planetary gears 34 rotate about the vehicle-width direction A as a central axis. The plurality of planetary gears 34 are arranged around the sun gear 33 in the outward direction B2. The plurality of planetary gears 34 are in mesh with the sun gear 33. The plurality of planetary gears 34 are rotatably supported by the planetary carrier 35.

The planetary carrier 35 includes a first carrier disk 41, a second carrier disk 42, and a gear support shaft 43. The first carrier disk 41 and the second carrier disk 42 each have a disk shape. The first carrier disk 41 and the second carrier disk 42 face each other in vehicle-width direction A. The first carrier disk 41 and the second carrier disk 42 each have a central axis that coincides with the central axis O. The first carrier disk 41 is disposed to the outward direction A1 side of the second carrier disk 42 in the vehicle-width direction A. The gear support shaft 43 is arranged along the vehicle-width direction A. The gear support shaft 43 has one end fixed to the first carrier disk 41 and the other end fixed to the second carrier disk 42. The planetary gears 34 are arranged around the gear support shaft 43.

The ring gear 36 is arranged around the plurality of planetary gears 34. The ring gear 36 has an annular shape. The ring gear 36 has a central axis that coincides with the central axis O. The ring gear 36 is fixed to the support section 14.

Rotation of the input shaft 21 causes the input gear 31 to rotate, and the sun gear 33 to rotate. Since the ring gear 36 is fixed to an outer peripheral portion 61 of the housing 24, rotation of the sun gear 33 causes the planetary gears 34 to rotate, and the planetary carrier 35 to rotate as well.

### (Output Shaft 23)

The output shaft 23 is configured to output the driving force of the travel motor that has been decelerated by the reducer 22. The output shaft 23 rotates around the central axis O along the vehicle-width direction A. The output shaft 23 includes a shaft body 51 and a connecting section 52. The shaft body 51 is arranged along the vehicle-width direction A. The shaft body 51 is arranged along the central axis O. The shaft body 51 has a first end 511 in the inward-direction A2 side of the vehicle-width direction A, and a second end 512 in the outward-direction A1 side of the vehicle-width direction A. The first end 511 is fixed to the first carrier disk 41 of the planetary carrier 35. To the output shaft 23, the output from the planetary carrier 35 of the planetary gear mechanism 32 is transmitted. The connecting section 52 is located at the second end 512 of the shaft body 51. The connecting section 52 extends from the second end 512 in the outward direction B2 of the radial direction B. The connecting section 52 has a disk-shaped outer configuration. The connecting section 52 is to be connected to the sprocket hub 71. The connecting section 52 has an outer peripheral edge portion 521 to be connected to the sprocket hub 71. The outer peripheral edge portion 521 is the end portion of the connecting section 52 in the outward direction B2 side of the radial direction B. The outer peripheral edge portion 521 is to be connected to the sprocket hub 71 with a bolt(s) 53.

### (Housing 24)

The housing 24 covers the planetary gear mechanism 32 in the outward-direction A1 side of the vehicle-width direction A. The housing 24 is fixed to the support section 14. The housing 24 has a central axis that coincides with the central axis O. The housing 24 has a disk shape with a through-hole formed at the center. The housing 24 includes an outer peripheral portion 61 and an inner peripheral portion 62.

The outer peripheral portion 61 includes a first end portion 611 and a second end portion 612. The first end portion 611 is located to the inward-direction A2 side of the second end portion 612 in the vehicle-width direction A. The first end portion 611 is disposed on the outward direction B2 side of the ring gear 36 in the radial direction B. The outer peripheral portion 61 extends from the first end portion 611 toward the second end portion 612 in the outward direction A1. The outer peripheral portion 61 has a diameter that decreases as it goes in the outward direction A1. The second end portion 612 is located to the inward-direction B1 side of the first end portion 611 in the radial direction B.

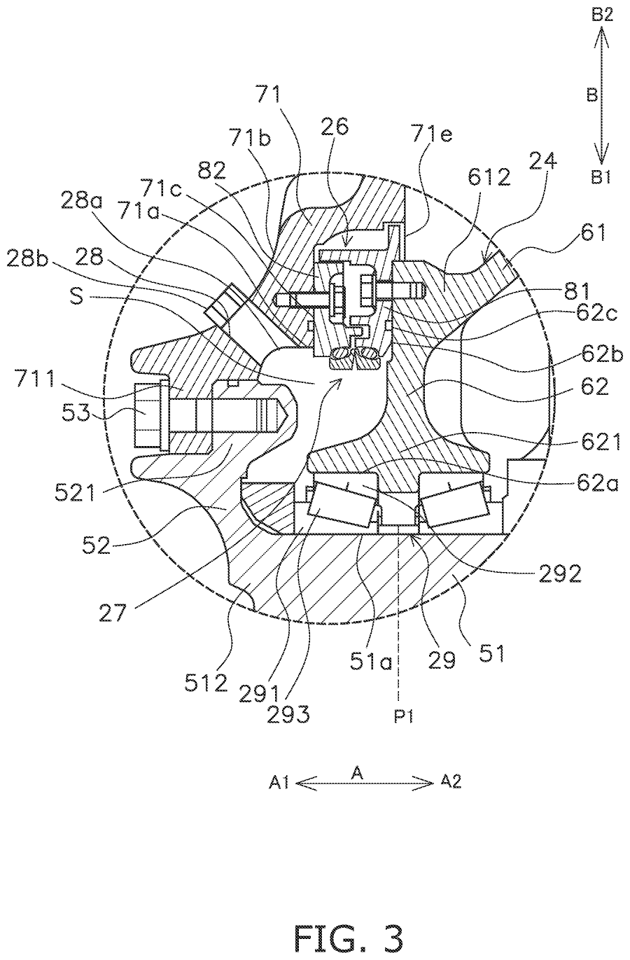

The inner peripheral portion 62 extends from the second end portion 612 of the outer peripheral portion 61 toward the inward direction B1 of the radial direction B. FIG. 3 is an enlarged sectional view of the inner peripheral portion 62 and the vicinity thereof. The inner peripheral portion 62 has, in the inward direction B1 of the radial direction B, an end 621 that extends along the central axis O both in the inward direction A2 and the outward direction A1 of the vehicle-width direction A. As shown in FIG. 3, the end 621 has an inner peripheral surface 62a facing an outer peripheral surface 51a of the shaft body 51. Between the inner peripheral surface 62a of the housing 24 and the outer peripheral surface 51a of the shaft body 51, a bearing 29 (an example of a bearing section) is arranged. The bearing 29 is arranged to the inward-direction B1 side of the housing 24 in the radial direction B. The bearing 29 has an inner ring 291, an outer ring 292, and a plurality of rollers 293. The inner ring 291 is fixed to the outer peripheral surface 51a of the shaft body 51. The outer ring 292 is fixed to the inner peripheral surface 62a of the housing 24. The plurality of rollers 293 are arranged between the inner ring 291 and the outer ring 292. With this configuration, the output shaft 23 is rotatably supported by the housing 24.

### (Sprocket Hub 71)

As shown in FIG. 2, the sprocket hub 71 is configured to be connected to the output shaft 23. The sprocket tooth 72 is continuous to the sprocket hub 71 and is in mesh with the crawler belt 12. As the output shaft 23 rotates, the sprocket hub 71 and the sprocket tooth 72 rotate, and the crawler belt 12 rotates. The sprocket component members include the sprocket hub 71 and the sprocket tooth 72.

The sprocket hub 71 has a disk shape. The sprocket hub 71 has an inner peripheral edge portion 711 and an outer peripheral edge portion 712. The inner peripheral edge portion 711 is an end portion of the sprocket hub 71 in the inward direction B1 side of the radial direction B. The outer peripheral edge portion 712 is an end portion of the sprocket hub 71 in the outward direction B2 side of the radial direction B.

The inner peripheral edge portion 711 is disposed to the outward-direction A1 side of the outer peripheral edge portion 712 in the vehicle-width direction A. The sprocket hub 71 has a configuration in which the diameter increases from an inner peripheral edge portion 711 toward an outer peripheral edge portion 712. The sprocket tooth 72 is fixed to the outer peripheral edge portion 712 with a bolt(s) 73.

As shown in FIG. 3, the inner peripheral edge portion 711 is connected to the outer peripheral edge portion 521 of the output shaft 23 by a bolt(s) 53. The inner peripheral edge portion 711 is disposed to the outward-direction A1 side of the outer peripheral edge portion 521 in the vehicle-width direction A. The bolt(s) 53 is inserted into the inner peripheral edge portion 711 and the outer peripheral edge portion 521 from the outward direction A1. This configuration allows the sprocket hub 71 to be removed from the output shaft 23 in the outward direction A1 of the vehicle-width direction A without interfering with the output shaft 23, after the bolt(s) 53 is removed in the outward direction A1 of the vehicle-width direction A.

As shown in FIG. 3, the sprocket hub 71 has an inner face portion 71a disposed on the side of the reducer 22, and an outer face portion 71b opposite to the inner face portion 71a. The inner face portion 71a is a surface of the sprocket hub 71 in the inward direction A2 side. The outer face portion 71b is a surface of the sprocket hub 71 in the outward direction A1 side. As shown in FIG. 3, the inner face portion 71a faces an outer face portion 62b of the housing 24. The outer face portion 62b is a surface of the inner peripheral portion 62 of the housing 24 in the outward direction A1 side of the vehicle-width direction A. A space S is defined between the opposing inner face portion 71a and outer face portion 62b. The space S is to be filled with lubricating oil.

Note that, in the vehicle-width direction A, the housing 24 partially overlaps with the sprocket hub 71. Specifically, as shown in FIG. 3, the outer face portion 62b of the inner peripheral portion 62 of the housing 24 is disposed to the outward-direction A1 side of an inner end 71e of the sprocket hub 71 in the vehicle-width direction. With this configuration, the space S can be arranged further in the outward direction A1.

### (Labyrinth Section 26)

The labyrinth section 26 is disposed between the inner face portion 71a of the sprocket hub 71 and the outer face portion 62b of the housing 24, as shown in FIG. 3. The labyrinth section 26 includes a fixed-side member 81 and a rotation-side member 82. The fixed-side member 81 is fixed to the outer face portion 62b of the housing 24. The fixed-side member 81 has an annular shape. The fixed-side member 81 is fixed to a mount portion 62c that is an end of the outer face portion 62b in the outward direction B2. The mount portion 62c is arranged perpendicular to the vehicle-width direction A.

The rotation-side member 82 is fixed to the inner face portion 71a of the sprocket hub 71. The rotation-side member 82 has an annular shape. The rotation-side member 82 is arranged to face the fixed-side member 81. The rotation-side member 82 is fixed to a mount portion 71c of the inner face portion 71a that is perpendicular to the central axis O of the sprocket hub 71. The rotation-side member 82 and the fixed-side member 81 form a labyrinth structure.

### (Floating Seal 27)

The floating seal 27 is arranged at an end portion of the space S, as shown in FIG. 3. The floating seal 27 is arranged at the end portion of the space S in the outward direction B2 side of the radial direction B. The floating seal 27 is arranged to the inward-direction B1 side of the labyrinth section 26. The floating seal 27 has a central axis that coincides with the central axis O. As shown in FIG. 2, the inner diameter R1 of the floating seal 27 is larger than the outer diameter R2 of the connecting section 52. With this configuration, when the sprocket hub 71 is removed from the connecting section 52 of the output shaft 23, the floating seal 27 can be accessed along the central axis O for servicing without interference with the connecting section 52.

As shown in FIG. 3, the floating seal 27 is arranged to the sprocket hub 71 side of the center position (indicated by P1 in the figure) of the bearing 29 in the vehicle-width direction A. With this configuration, the floating seal 27 can be placed further in the outward direction A1, thereby facilitating the maintenance.

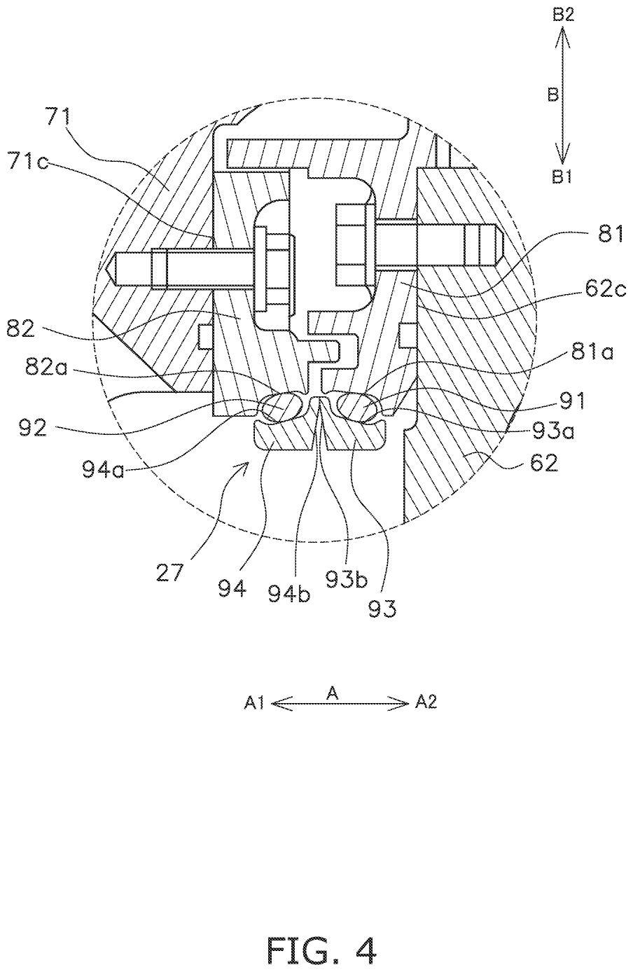

FIG. 4 is an enlarged cross-sectional view of the floating seal 27 and the vicinity thereof. The floating seal 27 includes a fixed-side O-ring 91, a rotation-side O-ring 92, a fixed-side seal ring 93, and a rotation-side seal ring 94.

The fixed-side O-ring 91 is a rubber ring with a circular cross-section. The fixed-side O-ring 91 is in contact with a surface 81a of the fixed-side member 81 in the inward direction B1 of the radial direction B. The fixed-side seal ring 93 is arranged to the inward-direction B1 side of the fixed-side O-ring 91.

The rotation-side O-ring 92 is a rubber ring with a circular cross-section. The rotation O-ring 92 is in contact with a surface 82a of the rotation-side member 82 in the inward direction B1. The rotation-side seal ring 94 is arranged to the inward-direction B1 side of the rotation-side O-ring 92.

The fixed-side seal ring 93 is comprised of metal. The fixed-side seal ring 93 has a facing surface 93a and a sliding surface 93b. The facing surface 93a faces the surface 81a of the fixed-side member 81 and is configured to contact the fixed-side O-ring 91. The sliding surface 93b is configured to slide while being in contact with the rotation-side seal ring 94. The sliding surface 93b is arranged along the radial direction B.

The rotation-side seal ring 94 is comprised of metal. The rotation-side seal ring 94 has a facing surface 94a and a sliding surface 94b. The facing surface 94a faces the surface 82a of the rotation-side member 82 and is configured to contact the rotation-side O-ring 92. The sliding surface 94b is configured to slide together with the sliding surface 93b of the fixed-side seal ring 93. The sliding surface 94b is arranged along the radial direction B. The sliding surfaces 93b and 94b provide sealing properties to the space S. As shown in FIG. 3, the space S is surrounded by the labyrinth section 26, the floating seal 27, the sprocket hub 71, the output shaft 23, the bearing 29, and the inner peripheral portion 62 of the housing 24.

### (Maintenance Hole 28)

As shown in FIG. 3, the maintenance hole 28 is formed in the sprocket hub 71. The maintenance hole 28 passes through the sprocket hub 71 from the outer face portion 71b to the inner face portion 71a. The maintenance hole 28 is in communication with the space S, for example. An opening 28a of the maintenance hole 28 on the inner face portion 71a side faces the space S. An opening of the maintenance hole 28 on the outer-face-portion 71b side is closed with a cap 28b or the like. In the present embodiment, the central axis of the maintenance hole 28 is arranged at an angle with respect to the central axis O.

By inserting a fiberscope, for example, through the maintenance hole 28, the conditions of the floating seal 27 and the bearing 29 can be checked for damage or the like. The remaining amount of lubricating oil, cleanliness, and other conditions may be checked through the maintenance hole 28. When the remaining lubricating oil is found to be small in quantity, additional lubricating oil may be supplied through the maintenance hole 28. A plurality of maintenance holes 28 may be formed circumferentially of the central axis O.

### (Operation)

The input shaft 21 is rotated by a travel motor (not shown). As shown in FIG. 2, the rotation of the input shaft 21 rotates the input gear 31 of the reducer 22. As the input gear 31 rotates, the sun gear 33 in mesh with the input gear 31 rotates.

The rotation of the sun gear 33 causes the planetary gears 34 arranged around the sun gear 33 to rotate. Here, since the ring gear 36 disposed on the planetary gears 34 in the outward direction B2 is fixed to the support section 14, the planetary carrier 35 also rotates as the planetary gears 34 rotates. As the planetary carrier 35 rotates, the output shaft 23 fixed to the planetary carrier 35 rotates while being supported by the housing 24.

As the output shaft 23 rotates, the sprocket hub 71 connected to the output shaft 23 also rotates. As the sprocket hub 71 rotates, the sprocket tooth 72 fixed to the sprocket hub 71 also rotates, and the crawler belt 12 wound around the sprocket tooth 72 rotates. As a result, the bulldozer 1 travels.

As shown in FIG. 4, the rotation-side seal ring 94 is disposed on the rotation-side member 82, which is fixed to the sprocket hub 71, via the rotation-side O-ring 92. Further, the fixed-side seal ring 93 is disposed, via the fixed-side O-ring 91, on the fixed-side member 81 fixed to the housing 24 that supports the output shaft 23. The space S can be sealed by the rotation-side seal ring 94 sliding against the fixed-side seal ring 93 as the output shaft 23 rotates. With this configuration, lubricating oil becomes less likely to leak from the space S, and earth and sand entering in the space S can be reduced.

### (Servicing Operation)

At the time of servicing of the floating seal 27, the bolt 53 shown in FIG. 1 is pulled off into the outward direction A1. Furthermore, the sprocket hub 71 is removed from the connecting section 52 into the outward direction A1.

These removals allow a worker to access the floating seal 27, and thereby the floating seal 27, the labyrinth section 26, and the other components can be maintained.

Furthermore, the conditions of the floating seal 27, the labyrinth section 26, and the lubricating oil can be checked through the maintenance hole 28 without removing the sprocket hub 71 from the connecting section 52.

### (Features and Others)

(1)

The travel driving apparatus 13 of the present embodiment is a travel driving apparatus 13 of the bulldozer 1 (an example of a work machine) having the reducer 22, and includes the output shaft 23, the sprocket hub 71, the housing 24, and the floating seal 27. Driving force is output from the reducer 22 to the output shaft 23. The sprocket hub 71 has the inner face portion 71a disposed on the side of the reducer 22, and is connected to the output shaft 23. The housing 24 has an outer face portion 62b facing the inner face portion 71a, and covers the reducer 22 from the side of the sprocket hub 71. The floating seal 27 is disposed at the end portion of the space S that is formed between the inner face portion 71a and the outer face portion 62b, and the space S is filled with lubricating oil.

By disposing the floating seal 27 at the end portion of the space S, a space can be secured to be defined adjacent to the floating seal 27. With this configuration, the space can be used for servicing such as replacement and maintenance of the floating seal 27, which thereby facilitates the servicing works.

(2)

The travel driving apparatus 13 of the present embodiment further includes the bearing 29 (an example of a bearing section). The bearing 29 is disposed between the output shaft 23 and the housing 24 and is in contact with the space S.

With the configuration, at the servicing of the floating seal 27, the bearing 29 can also be serviced. In addition, the bearing 29 can be lubricated by the lubricating oil that is sealed by the floating seal 27.

(3)

In the travel driving apparatus 13 of the present embodiment, the output shaft 23 includes the shaft body 51 and the connecting section 52. The connecting section 52 is arranged on a side opposite to the reducer 22 with respect to the housing 24, and is configured to connect the shaft body 51 and the sprocket hub 71. The housing 24 has the inner peripheral surface 62a facing the outer peripheral surface 51a of the shaft body 51. The bearing 29 is arranged between the inner peripheral surface 62a and the outer peripheral surface 51a.

This configuration allows the floating seal 27 between the sprocket hub 71 and the housing 24 to be placed closer to the outside (the opposite side to the reducer 22) along the output shaft 23, thereby making it easier to service the floating seal 27 during disassembly.

(4)

In the travel driving apparatus 13 of the present embodiment, the floating seal 27 is arranged closer to the sprocket hub 71 than the center (position P1) of the bearing 29 in the direction along the output shaft 23.

With this configuration, the floating seal 27 can be placed closer the outside along the output shaft 23 (the opposite side to the reducer 22), thereby facilitating the service of the floating seal 27 during disassembly.

(5)

In the travel driving apparatus 13 of the present embodiment, the output shaft 23 includes the shaft body 51 and the connecting section 52. The connecting section 52 is disposed on a side opposite to the reducer 22 with respect to the housing 24, extends radially outward from the shaft body 51, and is configured to be connected to the sprocket hub 71. The inner diameter R1 of the floating seal 27 is larger than the outer diameter R2 of the connecting section 52.

With the configuration, while the sprocket hub 71 is removed from the connecting section 52, the floating seal 27 can be visually recognized along the central axis O. Further, the floating seal 27 can be easily removed without interfering with the connecting section 52.

(6)

In the travel driving apparatus 13 of the present embodiment, the output shaft 23 includes the shaft body 51 and the connecting section 52. The connecting section 52 is disposed on a side opposite to the reducer 22 with respect to the housing 24, extends radially outward from the shaft body 51, and is configured to be connected to the sprocket hub 71 at the outer peripheral edge portion 521. The sprocket hub 71 has the inner peripheral edge portion 711 that overlaps the outer peripheral edge portion 521 of the connecting section 52. The outer peripheral edge portion 521 of the connecting section 52 is arranged closer to the reducer 22 than the inner peripheral edge portion 711 of the sprocket hub 71.

With the configuration, when removed from the shaft body 51, the sprocket hub 71 can be easily taken off without interfering with the connecting section 52 of the output shaft 23. As described above, the sprocket hub 71 can be easily disassembled from the output shaft 23, thereby improving the serviceability of the floating seal 27, such as replacement and maintenance.

(7)

In the travel driving apparatus 13 of the present embodiment, the sprocket hub 71 has the maintenance hole 28 formed from the outer face portion 71b on the side opposite to the reducer 22 to the inner face portion 71a.

This configuration enables the check of conditions of the labyrinth section 26, the floating seal 27, and the lubricating oil through the maintenance hole 28 without disassembling.

(8)

In the travel driving apparatus 13 of the present embodiment, the sprocket hub 71 has the maintenance hole 28 (an example of a hole) in communication with the space S.

With this configuration, the condition of the floating seal 27 and the condition of the lubricating oil can be checked through the maintenance hole 28 without disassembling.

(9)

In the travel driving apparatus 13 of the present embodiment, the output shaft 23 includes the shaft body 51 and the connecting section 52 configured to connect the shaft body 51 to the sprocket hub 71. The housing 24 partially overlaps the sprocket hub 71 in the direction along the shaft body 51.

This configuration allows the floating seal 27 between the sprocket hub 71 and the housing 24 to be positioned closer to the outside (the opposite side to the reducer 22) along the shaft body 51, thereby facilitating the servicing of the floating seal 27 during disassembly.

### OTHER EMBODIMENTS

One embodiment of the claimed invention has been described above. However, the claimed invention is not limited to the above embodiment, and various changes can be made without departing from the scope of the claimed invention. In particular, the multiple embodiments and modifications described in this specification can be arbitrarily combined as necessary.

### (A)

In the above embodiment, the driving force is input from the input shaft 21 to the sun gear 33 via the input gear 31. However, the claimed invention is not limited to this configuration. For example, the driving force may be directly input from the input shaft 21 to the sun gear 33 without going through the input gear 31.

### (B)

In the above embodiment, the maintenance hole 28 has the opening 28a located inward the radial direction of the floating seal 27, and the central axis of the opening 28a is arranged at an angle with respect to the central axis O so as to approach the central axis O as it goes in the inward direction A2. However, the claimed invention is not limited to this configuration. For example, a configuration is possible in which a through-hole is formed from the sprocket hub 71 to the rotation-side member 82, so that the state of the labyrinth section 26 can be checked through the through-hole. In this case, for example, a jig such as a fiberscope can be inserted through the maintenance hole 28 to check whether the labyrinth section 26 is clogged with earth and sand. A jig can also be inserted through the maintenance hole 28 to remove the earth and sand from the labyrinth section 26. In this case, the sprocket hub 71 and the rotation-side member 82 may be integrally formed.

### (C)

When a plurality of maintenance holes 28 are formed as described in the above embodiment, one of the maintenance holes 28 may be used to spray water therethrough for high-pressure cleaning.

### (D)

In the above embodiment, the bulldozer 1 is taken as an example of a work machine. However, the work machine is not limited to bulldozer, and any work machine having a crawler belt may be used, such as a hydraulic excavator.

According to the present disclosure, a travel driving apparatus can be provided in which the serviceability is improved.

1. A travel driving apparatus in a work machine including a reducer, the travel driving apparatus comprising:
an output shaft to which driving force is output from the reducer;
a sprocket hub including an inner face portion disposed on a side of the reducer, the sprocket hub being connected to the output shaft;
a housing including an outer face portion that faces the inner face portion, the housing covering the reducer from a side of the sprocket hub; and
a floating seal disposed at an end portion of a space formed between the inner face portion and the outer face portion, the space being filled with lubricating oil.

2. The travel driving apparatus according to claim 1, further comprising:
a bearing section disposed between the output shaft and the housing, the bearing section facing the space.

3. The travel driving apparatus according to claim 2, wherein
the output shaft includes
a shaft body, and
a connecting section disposed on a side opposite to the reducer with respect to the housing, and the connecting section is configured to connect the shaft body and the sprocket hub,
the housing includes an inner peripheral surface that faces an outer peripheral surface of the shaft body, and
the bearing section is arranged between the inner peripheral surface and the outer peripheral surface.

4. The travel driving apparatus according to claim 2, wherein
the floating seal is disposed to a side of the sprocket hub of a center position of the bearing section in a direction along the output shaft.

5. The travel driving apparatus according to claim 1, wherein
the output shaft includes
a shaft body, and
a connecting section disposed on a side opposite to the reducer with respect to the housing, the connecting section extends radially outward from the shaft body, and the connecting section is configured to be connected to the sprocket hub, and
the floating seal has an inner diameter larger than an outer diameter of the connecting section.

6. The travel driving apparatus according to claim 1, wherein
the output shaft includes
a shaft body, and
a connecting section disposed on a side opposite to the reducer with respect to the housing, the connecting section extends radially outward from the shaft body, and the connecting section is configured to be connected to the sprocket hub at an outer peripheral edge portion,
the sprocket hub includes an inner peripheral edge portion that overlaps the outer peripheral edge portion of the connecting section, and
the outer peripheral edge portion of the connecting section is disposed closer to the reducer than the inner peripheral edge portion of the sprocket hub is.

7. The travel driving apparatus according to claim 1, wherein
the sprocket hub has a hole that extends
from a surface on a side opposite to the reducer
to the inner face portion.

8. The travel driving apparatus according to claim 7, wherein
the hole is in communication with the space.

9. The travel driving apparatus according to claim 1, wherein
the output shaft includes:
a shaft body, and
a connecting section configured to connect the shaft body to the sprocket hub, and
the housing partially overlaps the sprocket hub in a direction along the shaft body.
